(19) United States
(12) Patent Application Publication
(10) Pub. No.: US 2025/0334913 A1
(43) Pub. Date: Oct. 30, 2025

(54) IMAGE FORMING APPARATUS WITH CALIBRATION FUNCTION

(71) Applicant: KYOCERA Document Solutions Inc., Osaka (JP)

(72) Inventors: Yasuaki SAKAMOTO, Osaka (JP); Makoto MATSUMOTO, Osaka (JP); Masaru WATANABE, Osaka (JP); Ayato MORIKAMI, Osaka (JP); Yukiko KOTANI, Osaka (JP); Atsuki ITO, Osaka (JP)

(73) Assignee: KYOCERA Document Solutions Inc., Osaka (JP)

(21) Appl. No.: 19/188,418

(22) Filed: Apr. 24, 2025

(30) Foreign Application Priority Data
Apr. 26, 2024 (JP) 2024-072937

(51) Int. Cl. G03G 15/00; G03G 15/02; G03G 15/043; G03G 15/06

(52) U.S. Cl. CPC G03G 15/5058; G03G 15/0266; G03G 15/043; G03G 15/065

(57) ABSTRACT

An image forming apparatus includes an image forming device, a controller, a density measurement device, and a calculator. The calculator detects a relationship (approximation line L1) between a control amount CV related to an image forming operation and a density D of an image formed on a photoconductor drum, which is an image carrier, and calculates a set value CV_TD of the control amount CV corresponding to a target density TD on the basis of the relationship. The controller forms a patch image on the photoconductor drum by using the set value CV_TD. The calculator calibrates the relationship on the basis of a difference ΔD between a density D10 of the patch image and the target density TD, and corrects the set value CV_TD on the basis of the calibrated relationship.

### INCORPORATION BY REFERENCE

This application claims priority to Japanese Patent Application No. 2024-072937 filed on Apr. 26, 2024, the entire contents of which are incorporated by reference herein.

### BACKGROUND

The present disclosure relates to an image forming apparatus, and particularly, to an image forming apparatus with a calibration function.

Some image forming apparatuses, such as printers, have a calibration function. For example, there is known an image forming apparatus that forms a patch image on an image carrier and executes calibration for maintaining image quality on the basis of the density of the patch image.

### SUMMARY

As one aspect of the present disclosure, technology that further improves the above technology is proposed.

An image forming apparatus according to one aspect of the present disclosure includes an image forming device, a controller, a density measurement device, and a calculator. The image forming device has an image carrier, forms an image on a surface of the image carrier, and transfers the image to a recording medium to form an image on the recording medium. The controller changes a control amount related to an image forming operation in the image forming device to control an operation of the image forming device and form a plurality of first patch images with different densities on the image carrier. The density measurement device measures a density of the image formed on the image carrier. The calculator calculates a set value of the control amount corresponding to a predetermined target density based on the control amount when each of the first patch images is formed and a density of each of the first patch images which is measured by the density measurement device. The controller controls the operation of the image forming device by using the set value calculated by the calculator and forms a second patch image on the image carrier, the calculator calibrates the set value based on a difference between a density of the second patch image which is measured by the density measurement device and the target density, and the controller uses the set value calibrated by the calculator as a control amount during a normal image formation operation by the image forming device.

### BRIEF DESCRIPTION OF THE DRAWINGS

FIG. 1 is a front cross-sectional view showing the structure of an image forming apparatus according to an embodiment of the present disclosure.

FIG. 2 is a schematic functional block diagram showing a main internal configuration of the image forming apparatus according to the embodiment of the present disclosure.

FIG. 3A is a graph showing an example of a relationship between a control amount related to an image forming operation and image density, and FIG. 3B is a diagram showing a relationship between a control amount and image density.

FIG. 4 is a flowchart showing an example of a process performed by a control device in the image forming apparatus.

FIG. 5 is a diagram showing a difference between the density of a second patch image and a target density.

FIGS. 6A and 6B are diagrams showing an example of a method of calibrating a relationship between a control amount and image density.

### DETAILED DESCRIPTION

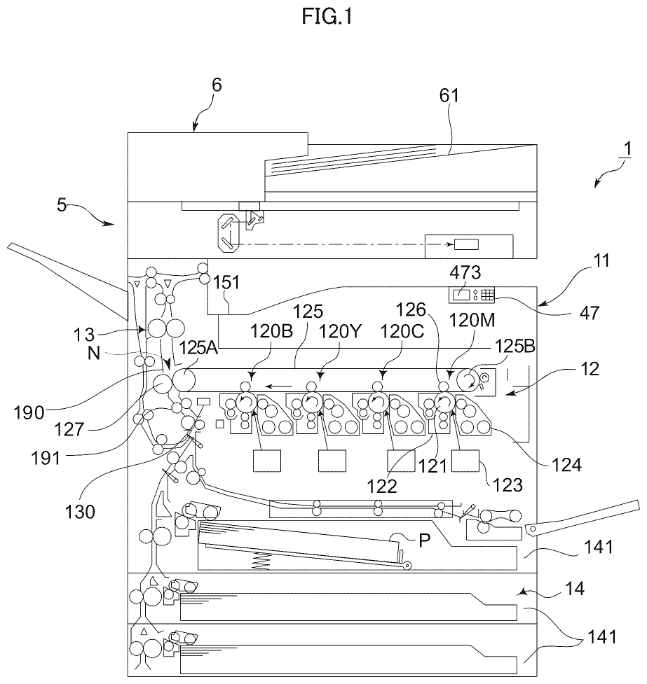

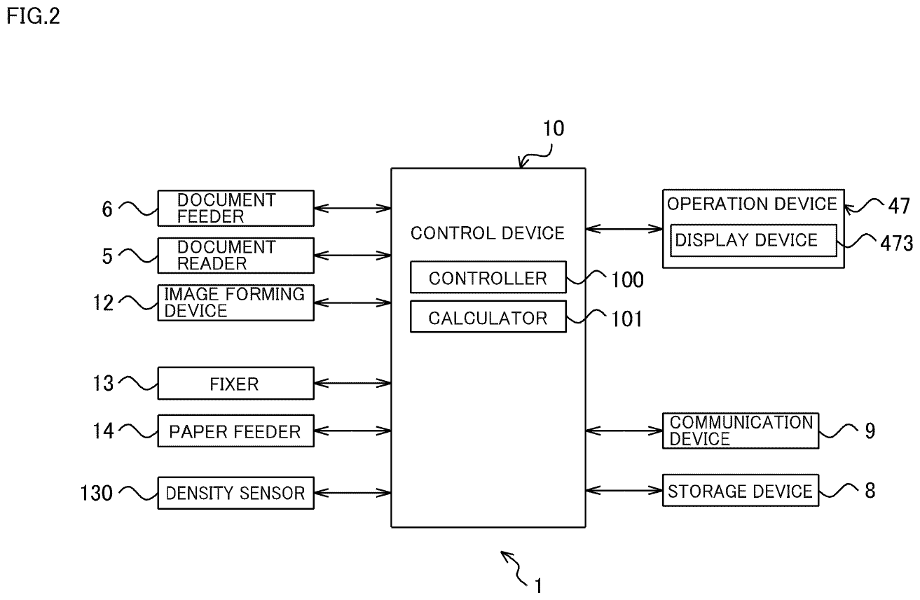

An image forming apparatus according to an embodiment of the present disclosure will be described below with reference to the drawings. FIG. 1 is a front cross-sectional view showing the structure of the image forming apparatus according to the embodiment of the present disclosure. FIG. 2 is a schematic functional block diagram showing a main internal configuration of the image forming apparatus according to the embodiment of the present disclosure.

An image forming apparatus 1 is a multifunction machine having a plurality of functions such as a copy function, a printer function, a scanner function, and a fax function. The image forming apparatus 1 includes a control device 10, a document feeder 6, a document reader 5, an image forming device 12, a fixer 13, a paper feeder 14, a density sensor 130, an operation device 47, a communication device 9, and a storage device 8.

The document feeder 6 is configured to be openable and closable on the upper surface of the document reader 5 by means of a hinge or the like (not shown), and functions as a document holder cover when reading a document placed on a platen glass (not shown). The document feeder 6 is also an auto document feeder (ADF), includes a document tray 61, and supplies documents placed on the document tray 61 to the document reader 5.

The document reader 5 includes a scanner and the like, and reads documents fed from the document feeder 6 or reads documents placed on the platen glass.

A case where the image forming apparatus 1 performs a document reading operation will be described. The document reader 5 optically reads an image of a document supplied by the document feeder 6 or a document placed on the platen glass, and generates image data. The image data generated by the document reader 5 is stored in an image memory (not shown) or the like.

A case where the image forming apparatus 1 performs an image forming operation will be described. The image forming device 12 is equipped with image forming devices 120B, 120Y, 120C, and 120M (hereinafter collectively referred to as “image forming devices 120”) of respective colors (black, yellow, cyan, magenta). Each of the image forming devices 120 is equipped with a photoconductor drum 121 which is an image carrier that carries a toner image, a charging apparatus 122, an exposure apparatus 123, a development apparatus 124, and a primary transfer apparatus (primary transfer roller 126), and is a mechanism that forms an image on recording paper which is a recording medium by secondary transfer via an intermediate transfer belt 125 stretched around a driving roller 125A and a driven roller 125B. The photoconductor drum 121 is an example of an image carrier in the claims.

The charging apparatus 122 charges the surface of the photoconductor drum 121. The exposure apparatus 123 exposes the charged surface of the photoconductor drum 121 to light, forming an electrostatic latent image on the surface of the photoconductor drum 121. The development apparatus 124 contains a toner for developing the electrostatic latent image, and develops the electrostatic latent image formed on the surface of the photoconductor drum 121.

The image forming device 120 for each color forms a toner image on the photoconductor drum 121 through charging, exposure, and development processes on the basis of an image configured with each color component, and transfers the toner image onto the intermediate transfer belt 125 by the primary transfer roller 126. The intermediate transfer belt 125 is an example of an image carrier in the claims.

In the intermediate transfer belt 125, an image carrying surface having an outer peripheral surface onto which the toner image is transferred is set, and the intermediate transfer belt 125 is driven by the driving roller 125A while in contact with the peripheral surface of the photoconductor drum 121. The intermediate transfer belt 125 runs endlessly between the driving roller 125A and the driven roller 125B in synchronization with each photoconductor drum 121.

The toner images of the respective colors transferred onto the intermediate transfer belt 125 are superimposed on the intermediate transfer belt 125 to form a color toner image. The secondary transfer roller 127 transfers the color toner image formed on the surface of the intermediate transfer belt 125 to recording paper P transported from the paper feeder 14 by a transport roller pair 191 provided at an appropriate position on a transport path 190 at a nip portion N between the secondary transfer roller 127 and the driving roller 125A with the intermediate transfer belt 125 interposed therebetween.

The image forming device 12 includes a density sensor 130 that measures the density of the toner image transferred to the intermediate transfer belt 125. The density sensor 130 is disposed upstream of the secondary transfer roller 127 in the moving direction of the intermediate transfer belt 125, and measures the density of a first patch image PT1 and a second patch image PT2, which will be described later.

The density sensor 130 is an optical sensor. The density sensor 130 includes a light emitting device (not shown) that irradiates the intermediate transfer belt 125 with light, and a light receiving device (not shown) that receives reflected light of the light emitted by the light emitting device. The density sensor 130 is an example of a density measurement device in the claims.

Under the control of the controller 100, the image forming device 12 forms a toner image on recording paper fed from the paper feeder 14 on the basis of image data generated by a document reading operation, image data stored in an image memory or the like, and image data received from a computer connected thereto via a network to create printed matter.

The paper feeder 14 includes a paper feed cassette 141, and further includes a pick-up roller that picks up the recording paper P from the paper feed cassette 141 and feeds it to the image forming device 12, a transport roller, a transport path, and a rotation drive mechanism for each roller.

The fixer 13 is a fixing apparatus that includes a heat roller, a pressure roller, and a drive mechanism that drives these rollers to rotate. The fixer 13 fixes the toner image to the recording paper P by applying heat and pressure to the recording paper P on which the toner image has been formed by the image forming device 12 at a nip between the two rollers, and the recording paper P that has been subjected to the fixing process is discharged to a discharge tray 151.

The operation device 47 includes various hard keys operated by a user, and receives instructions, such as an image forming operation execution instruction, from the user for various operations and processes that can be executed by the image forming apparatus 1 in response to the operation of the hard keys.

The operation device 47 includes a display device 473 that displays operation guides and the like to the operator. In addition, the operation device 47 receives an input of an instruction from the user based on the user's operation (touch operation) on a screen displayed on the display device 473 via a touch panel of the display device 473.

The display device 473 is configured with a liquid crystal display (LCD) or the like. When the operator touches a button or a key displayed on the screen, the touch panel receives an instruction associated with the touched position. In this case, the touch panel functions as an operation device.

The communication device 9 is a communication interface that transmits and receives various data to and from external devices (for example, a personal computer) in a local area or on the Internet.

The storage device 8 is a large-capacity storage device such as a hard disk drive (HDD) or a solid state drive (SSD), and stores various control programs and the like.

The control device 10 includes a processor, a random access memory (RAM), a read only memory (ROM), and a dedicated hardware circuit. The processor is, for example, a central processing unit (CPU), an application specific integrated circuit (ASIC), a micro processing unit (MPU), or the like. The control device 10 includes the controller 100 and a calculator 101.

The control device 10 functions as the controller 100 and the calculator 101 by the operation of the processor according to a control program stored in the storage device 8. However, the controller 100 and the like can also be configured with a hardware circuit, regardless of the operation according to the control program by the control device 10. The same applies to each embodiment unless otherwise stated below.

The controller 100 is responsible for the overall operation control of the image forming apparatus 1. The controller 100 is connected to the document feeder 6, the document reader 5, the image forming device 12, the fixer 13, the paper feeder 14, the density sensor 130, the operation device 47, the communication device 9, and the storage device 8, and controls the driving of each of these devices. For example, the controller 100 executes various processes necessary for image formation by the image forming apparatus 1.

In addition, the controller 100 controls the operation of the image forming device 12 by using a control amount CV related to the image forming operation in the image forming device 12 to form an image on the recording medium. The control amount CV is, for example, one or more values of a charging bias applied to the photoconductor drum 121 by the charging apparatus 122, an amount of light exposure on the photoconductor drum 121 from emission by the exposure apparatus 123, and a development bias applied to the development apparatus 124. It is possible to arbitrarily set which one is set to be the control amount CV.

Next, description will be given of a case where a plurality of first patch images PT1 with different densities are formed on the intermediate transfer belt 125, a density D of these plurality of first patch images PT1 is measured, and calibration is executed on the basis of the measured density D.

When calibration is executed, the controller 100 forms the plurality of first patch images PT1 with different densities D on the intermediate transfer belt 125 by the image forming device 12 by using a plurality of (for example, four) different control amounts CV related to the image forming operation in the image forming device 12. For example, the controller 100 changes the control amount CV stepwise within the range of an upper limit value and a lower limit value to form the plurality of first patch images PT1 with different densities D on the intermediate transfer belt 125.

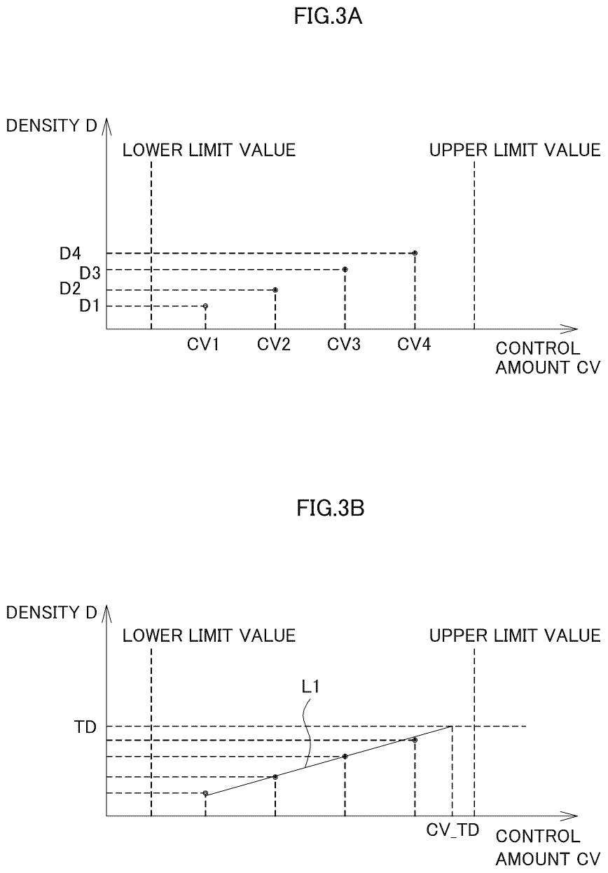

FIG. 3A is a graph showing an example of a relationship between a control amount CV and a density D. In FIG. 3A, the horizontal axis represents the control amount CV, and the vertical axis represents the density D measured by the density sensor 130. Four points of data are shown in FIG. 3A, and the four points of data respectively correspond to four first patch images PT1 formed on the intermediate transfer belt 125. FIG. 3A shows that the densities of the first patch images PT1 formed on the intermediate transfer belt 125 with control amounts CV1 to CV4 are densities D1 to D4, respectively.

The calculator 101 detects a relationship RA between a control amount CV and a density D of an image formed on the photoconductor drum 121 on the basis of the control amounts CV1 to CV4 with which the first patch images PT1 are formed and the densities D1 to D4 of the first patch images PT1 measured by the density sensor 130, and calculates a set value CV_TD of the control amount CV corresponding to a predetermined target density TD on the basis of the detected relationship RA.

FIG. 3B is a diagram showing a relationship RA between the control amount CV and the density D. The relationship RA is expressed by an approximation line L1 that passes close to all of the four points of data. The calculator 101 calculates, for example, an arithmetic expression F1 (an arithmetic expression that shows the relationship RA between the control amount CV and the density D) that shows the approximation line L1 by using the least squares method, and calculates a set value CV_TD of the control amount CV that corresponds to the target density TD using the calculated arithmetic expression F1, as shown in FIG. 3B.

The formation of the first patch image PT1 and the calculation of the set value CV_TD are performed for each of the image forming devices 120B, 120Y, 120C, and 120M of the respective colors.

Next, the calibration of the set value CV_TD will be described. As the calibration, the controller 100 controls the operation of the image forming device 12 by using the set value CV_TD calculated by the calculator 101, and further forms the second patch image PT2 on the photoconductor drum 121. For example, the controller 100 forms the second patch image PT2 on the photoconductor drum 121 at a timing (when an image to be transferred to a recording medium is not formed on the photoconductor drum 121 and the intermediate transfer belt 125) other than a normal image forming operation executed on the basis of a printing job (method 1). Alternatively, when an image to be transferred to a recording medium is formed on the photoconductor drum 121 and the intermediate transfer belt 125 during the normal image forming operation, the controller 100 forms the second patch image PT2 in a region on the intermediate transfer belt 125 where an image to be transferred to a recording medium is not formed (method 2). The density sensor 130 measures the density of each second patch image PT2.

The calculator 101 calibrates the relationship RA on the basis of a difference ΔD between a density D10 of the second patch image PT2 measured by the density sensor 130 and the target density TD, and calibrates the set value CV_TD when each of the second patch images is formed on the basis of the calibrated relationship RA.

The controller 100 uses the set value CV_TD, which is calibrated by the calculator 101 in this manner, as a control amount during the normal image formation operation by the image forming device 12.

The formation of the second patch image PT2 and the calibration of the set value CV_TD are performed for each of the image forming devices 120B, 120Y, 120C, and 120M of the respective colors. The controller 100 uses the set value CV_TD for each of the image forming devices 120B, 120Y, 120C, and 120M calibrated by the calculator 101 as a control amount during the normal image formation operation by each of the image forming devices 120B, 120Y, 120C, and 120M.

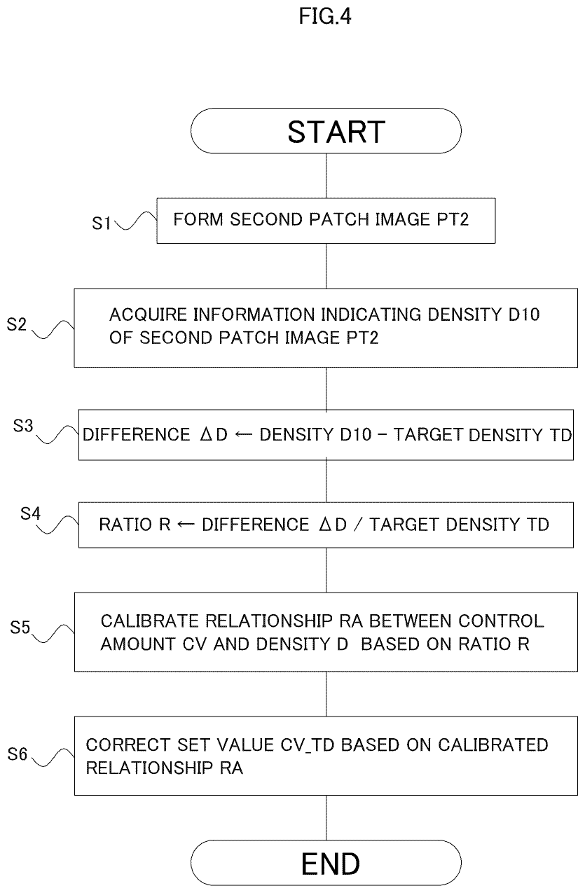

Next, an example of a process related to calibration of the set value CV_TD in the image forming apparatus 1 will be described using a flowchart shown in FIG. 4. This process is performed after the set value CV_TD is calculated by the calculator 101.

First, the controller 100 controls the operation of the image forming device 12 by using the set value CV_TD calculated by the calculator 101, and forms the second patch image PT2 on the intermediate transfer belt 125 (S1).

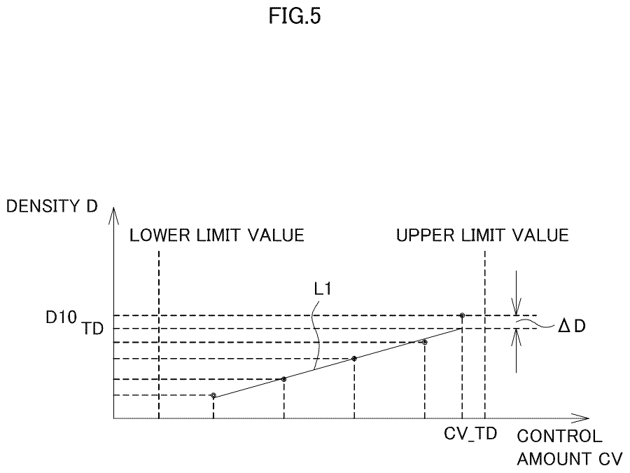

The calculator 101 acquires information indicating the density D10 of the second patch image PT2 measured by the density sensor 130 (S2), calculates the difference ΔD (see FIG. 5) between the density D10 of the second patch image PT2 indicated by the acquired information and the target density TD (S3), and calculates a ratio R of the difference ΔD to the target density TD (S4). FIG. 5 is a diagram showing the difference ΔD between the density D10 of the second patch image PT2 and the target density TD.

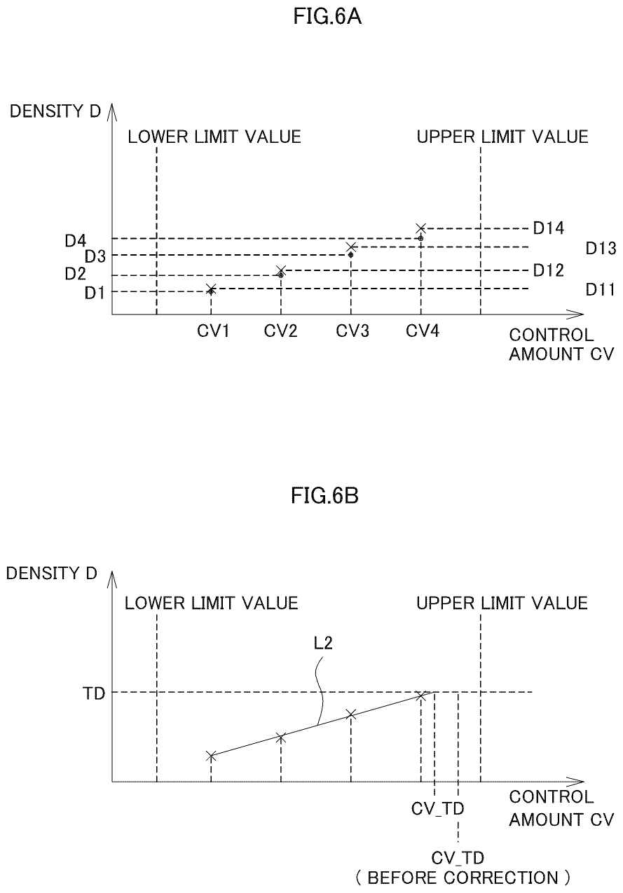

Subsequently, the calculator 101 calibrates the above-mentioned relationship RA on the basis of the ratio R calculated from the target density TD and the difference ΔD (S5). FIGS. 6A and 6B are diagrams showing an example of a method of calibrating the relationship RA.

Four points of data indicated by circles in FIG. 6A are the same as the four points of data shown in FIG. 3A, and the four points of data indicated by crosses in FIG. 6A are calibrated by adding the densities D1 to D4 of these points of data by the ratio R. For example, a density D14 is obtained by adding the density D4 by the ratio R, and can be expressed by an arithmetic expression of D14=D4+D4×R. When the density D10 is smaller than the target density TD, the ratio R is subtracted instead of added, and thus the density D14 is D14=D4−D4×R.

The relationship RA between the control amount CV and the density D after the calibration can be expressed as an approximation line L2 that passes as close as possible to the four points of data indicated by crosses, as shown in FIG. 6B. The calculator 101 calculates an arithmetic expression F2 (an arithmetic expression showing the relationship RA between the control amount CV and the density D) that shows the approximation line L2 using the least squares method.

The calculator 101 calibrates the set value CV_TD on the basis of the calibrated relationship RA (S6). Thereafter, the process ends. The calculator 101 calculates the set value CV_TD of the control amount CV that corresponds to the target density TD by using the calculated arithmetic expression F2 to calibrate the set value CV_TD, as shown in FIG. 6B.

According to the above embodiment, the relationship RA between the control amount CV and the density D of the image formed on the photoconductor drum 121 is calibrated, and the set value CV_TD of the control amount CV corresponding to the target density TD is calibrated on the basis of the calibrated relationship RA. Thereby, it is possible to appropriately calibrate the set value CV_TD and use the calibrated set value CV_TD as the control amount CV. Thereby, it is possible to more accurately calculate a set value of the control amount CV related to an image forming operation and stabilize the image quality.

In the above embodiment, a case where the controller 100 forms only one second patch image PT1 on the photoconductor drum 121 has been described, but as another embodiment, the controller 100 forms a plurality of second patch images PT2 on the photoconductor drum 121, and the calculator 101 calculates an average value of densities D10 of the plurality of second patch images PT2 measured by the density sensor 130 and calibrates the relationship RA on the basis of a difference between the average value and the target density TD. Thereby, it is possible to more appropriately correct the set value CV_TD.

Generally, in calibration, a set value of a control amount corresponding to a predetermined target density is calculated on the basis of a relationship between a control amount (for example, a bias and the amount of light) related to an image formation operation and the density of an image (development process characteristics) based on the density of a plurality of patch images with different densities formed on an image carrier. However, since the density of each patch image varies depending on its formation position on the image carrier, the calculated set value may not be sufficiently accurate, and the image quality may not be stable even when calibration is executed in such a calculation method. In addition, a required set value for the development process characteristics may change with deterioration over time. In contrast, according to this embodiment, it is possible to more accurately calculate the set value of the control amount related to the image formation operation and stabilize image quality.

The disclosure is not limited to the configuration of the above embodiment, and various modifications can be made. Further, in the above embodiment, the configurations and processes shown in the above embodiment using FIGS. 1 to 6 are merely one embodiment of the disclosure, and it is not intended to limit the disclosure to the configurations and processes.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
an image forming device that has an image carrier, forms an image on a surface of the image carrier, and transfers the image to a recording medium to form an image on the recording medium;
a density measurement device that measures a density of the image formed on the image carrier; and
a control device that includes a processor and functions, through the processor executing a control program, as a controller that changes a control amount related to an image forming operation in the image forming device to control an operation of the image forming device and form a plurality of first patch images with different densities on the image carrier, and a calculator that calculates a set value of the control amount corresponding to a predetermined target density based on the control amount when each of the first patch images is formed and a density of each of the first patch images which is measured by the density measurement device,
wherein the controller controls the operation of the image forming device by using the set value calculated by the calculator and forms a second patch image on the image carrier,
the calculator calibrates the set value based on a difference between a density of the second patch image which is measured by the density measurement device and the target density, and
the controller uses the set value calibrated by the calculator as a control amount during a normal image formation operation by the image forming device.

2. The image forming apparatus according to claim 1, wherein the calculator calculates an arithmetic expression showing an approximation line for a distribution of values showing the densities of the first patch images, which are measured by the density measurement device, by the least squares method, and calculates a set value of the control amount corresponding to the target density using the arithmetic expression.

3. The image forming apparatus according to claim 1, wherein the controller forms the second patch image on the image carrier at a timing other than when the normal image forming operation is executed, or forms the second patch image on the image carrier in a region where an image to be transferred to the recording medium is not formed when the normal image forming operation is executed.

4. The image forming apparatus according to claim 1, wherein
the controller forms a plurality of the second patch images on the image carrier, and
the calculator calculates an average value of densities of the plurality of the second patch images which are measured by the density measurement device, and calibrates the set value based on a difference between the average value and the target density.

5. The image forming apparatus according to claim 1, wherein
the image forming device includes a charging apparatus that charges the surface of the image carrier, an exposure apparatus that exposes the charged surface of the image carrier to light to form an electrostatic latent image on the surface of the image carrier, and a development apparatus that develops the electrostatic latent image formed on the surface of the image carrier, and
the control amount is at least one of a charging bias applied to the image carrier by the charging apparatus, an amount of light exposure on the image carrier from emission by the exposure apparatus, and a development bias applied to the development apparatus.
